(19) United States
(12) Patent Application Publication
(10) Pub. No.: US 2022/0146235 A1
(43) Pub. Date: May 12, 2022

(54) BALLISTIC-RESISTANT ARTICLE BASED ON SHEETS WITH DISCONTINUOUS FILM SPLITS

(71) Applicants: TEIJIN ARAMID B.V., Arnhem (NL); TEIJIN ARAMID GMBH, Wuppertal (DE)

(72) Inventors: Ruben CALIS, Pannerden (NL); Ben ROLINK, Ugchelen (NL); Christian BÖTTGER, Remscheid (DE); Marc-Jan DE HAAS, Apeldoorn (NL); Marcin DOMBROWSKI, Wuppertal (DE); Sebastianus PIERIK, Lent (NL)

(73) Assignees: TEIJIN ARAMID B.V., Arnhem (NL); TEIJIN ARAMID GMBH, Wuppertal (DE)

(21) Appl. No.: 17/429,716

(22) PCT Filed: Feb. 12, 2020
(86) PCT No.: PCT/EP2020/053540

§ 371 Date: Aug. 10, 2021

(30) Foreign Application Priority Data
Feb. 12, 2019 (EP) 19156663.7

(51) Int. Cl. F41H 5/04; B32B 7/09; B32B 27/08; B32B 27/32; B32B 37/18; B29C 43/00; B29C 43/20

(52) U.S. Cl. CPC F41H 5/0485; B32B 7/09; B32B 27/08; B32B 27/32; B32B 2038/008; B29C 43/003; B29C 43/203; B32B 2307/516; B32B 2571/02; B32B 37/182

(57) ABSTRACT

A ballistic-resistant articles, and methods for their preparation, based on sheets of UHMWPE films with discontinuous film splits, which combine flexibility and good ballistic properties, making them suitable for both soft-ballistic and hard-ballistic applications.

The instant invention relates to ballistic-resistant articles based on sheets of UHMWPE films with discontinuous film splits and to methods for their preparation.

Assemblies comprising UHMWPE films have been used as ballistic resistant articles due to their attractive ballistic properties. For instance, EP 1 627 719 describes a ballistic-resistant article consisting essentially of ultra-high molecular weight polyethylene which comprises a plurality of unidirectionally oriented polyethylene sheets crossplied at an angle with respect to each other and attached to each other in the absence of any resin, bonding matrix, or the like. WO 2009/109632 describes a ballistic-resistant moulded article comprising a compressed stack of sheets comprising tapes and an organic matrix material, the direction of the tapes within the compressed stack being not unidirectionally, with the stack comprising 0.2-8 wt. % of an organic matrix material.

However, the use of UHMWPE films generally provides assemblies which tend to be stiff and their use is mostly limited to hard ballistic applications.

For soft ballistic applications, ballistic-resistant articles tend to rely on the use of fibrous materials such as fibers or yarns as they tend to provide assemblies of a flexible nature. For instance, WO 2006/002977 describes a ballistic-resistant assembly comprising a stack of a plurality of flexible elements comprising at least one layer containing a network of high-strength fibres. WO 92/08607 describes an article comprising a plurality of flexible fibrous layers at least two of which are secured together by a securing means. Even though these documents mention the use of ribbons, strips or tapes, they focus on the use of fibers (e.g. laminated fiber fabrics and woven fiber fabrics).

The ballistic properties of assemblies based on UHMWPE films makes them attractive also for soft ballistic applications. However, for such applications flexibility is also important. Flexibility may also be important in the shaping of ballistic resistant articles, even ballistic resistant articles for hard ballistic applications.

Thus, there is a need for ballistic-resistant articles based on UHMWPE films which are both flexible and display good ballistic properties.

A ballistic-resistant article has now been found based on UHMWPE sheets that have good ballistic and flexibility properties. In particular, the ballistic-resistant article comprises a stack of sheets of UHMWPE films comprising discontinuous film splits. In particular, the present invention is directed to a ballistic-resistant article comprising a stack of sheets, the sheets comprising at least a first layer of unidirectionally oriented UHMWPE films and a second layer of unidirectionally oriented UHMWPE films, the direction of the films in the first layer being at an angle with respect to the direction of the films in the second layer, wherein the sheets comprise discontinuous film splits through at least the first and the second layers of films, the density of the film splits being of 1000 to 500 000 film splits per m², and wherein the sheets in the stack are consolidated. In the ballistic-resistant article according to the invention at least 50% of the split centres of a first layer are aligned along a line essentially perpendicular to the surface of the layer with the split centres of an adjacent second layer.

In the context of the present specification the term film means an object of which the length, i.e., the largest dimension of the object, is larger than the width, i.e., the second smallest dimension of the object, and the thickness, i.e., the smallest dimension of the object, while the width is in turn larger than the thickness. For the purposes of the present specification a UHMWPE film is regarded to have two film surfaces, i.e. the top and bottom planes defined by the length and width dimensions of the film.

The ratio between the length and the width of a film as described herein generally is at least 10. Depending on the film width the ratio may be larger, e.g., at least 100, or at least 1000. The maximum ratio is not critical to the present invention. As a general value, a maximum length to width ratio of 1 000 000 may be mentioned. The ratio between the width and the thickness generally is more than 10:1, in particular more than 50:1, still more in particular more than 100:1. The maximum ratio between the width and the thickness is not critical to the present invention. It generally is at most 10000:1.

The ultra-high molecular weight polyethylene (UHMWPE) of a film as described herein may generally have a weight average molecular weight (Mw) of at least 300 000 gram/mole, in particular of at least 500 000 gram/mole, more in particular from 1·10⁶ gram/mole to 1·10⁸ gram/mole.

The weight average molecular weight (Mw) may be determined in accordance with ASTM D 6474-99 at a temperature of 160° C. using 1, 2, 4-trichlorobenzene (TCB) as solvent. Appropriate chromatographic equipment (PL-GPC220 from Polymer Laboratories) including a high temperature sample preparation device (PL-SP260) may be used. The system is calibrated using sixteen polystyrene standards (Mw/Mn<1·1) in the molecular weight range 5×10³ to 8×10⁶ g/mole.

The molecular weight distribution may also be determined using melt rheometry. A polyethylene sample to which 0.5 wt. % of an antioxidant (e.g. IRGANOX 1010) has been added to prevent thermo-oxidative degradation, is first sintered at 50° C. and 200 bars. Disks of 8 mm diameter and thickness of 1 mm obtained from sintered polyethylene are heated fast (at about 30° C./min) to well above the equilibrium melting temperature in the rheometer under nitrogen atmosphere. For example, the disk may be kept at 180° C. for two hours or more. The slippage between the sample and rheometer discs may be checked with the help of an oscilloscope. During dynamic experiments two output signals from the rheometer i.e. one signal corresponding to sinusoidal strain, and the other signal to the resulting stress response, are monitored continuously by an oscilloscope. A perfect sinusoidal stress response, which can be achieved at low values of strain is indicative of no slippage between the sample and discs. Rheometry may be carried out using a plate-plate rheometer such as Rheometrics RMS 800 from TA Instruments. The Orchestrator Software provided by the TA Instruments, which makes use of the Mead algorithm, may be used to determine molar mass and molar mass distribution from the modulus vs frequency data determined for the polymer melt. The data is obtained under isothermal conditions between 160-220° C. To get the good fit angular frequency region between 0.001 to 100 rad/s and constant strain in the linear viscoelastic region between 0.5 to 2% should be chosen. The time-temperature superposition is applied at a reference temperature of 190° C. To determine the modulus below 0.001 frequency (rad/s) stress relaxation experiments may be performed. In the stress relaxation experiments, a single transient deformation (step strain) to the polymer melt at fixed temperature is applied and maintained on the sample and the time dependent decay of stress is recorded.

A UHMWPE film as described herein may generally be free from polymer solvent due to its manufacturing method, as will be described in more detail below. For instance, the UHMWPE films may generally have a polymer solvent content of less than 0.05 wt. %, in particular less than 0.025 wt. %, more in particular less than 0.01 wt. %.

UHMWPE films which may be used in the present invention may be manufactured by solid state processing of the UHMWPE, which process comprises compacting a UHMWPE powder into a panel, rolling and optionally stretching the resulting compacted panel to form a film, preferably under such conditions that at no point during the processing of the polymer its temperature is raised to a value above its melting point. Suitable methods for solid state processing of UHMWPE are known in the art and require no further elucidation here. Reference is made to, e.g., WO 2009/109632, WO 2009/153318 and WO 2010/079172. Suitable UHMWPE films are commercially available, e.g., from Teijin under the trademark Endumax®.

The starting material for manufacturing such UHMWPE films may be a highly disentangled UHMWPE. The elastic shear modulus G°_{N} directly after melting at 160° C. is a measure for the degree of entangledness of the polymer. In particular, the starting polymer may have an elastic shear modulus G°_{N} determined directly after melting at 160° C. of at most 1·4 MPa, in particular at most 1·0 MPa, more in particular at most 0.9 MPa, still more in particular at most 0.8 MPa, and even more in particular at most 0.7 MPa. The wording “directly after melting” means that the elastic modulus is determined as soon as the polymer has melted, in particular within 15 seconds after the polymer has melted. For this polymer melt, the elastic modulus typically increases from 0.6 to 2.0 MPa in several hours. G°_{N} is the elastic shear modulus in the rubbery plateau region. It is related to the average molecular weight between entanglements (Mₑ), which in turn is inversely proportional to the entanglement density. In a thermodynamically stable melt having a homogeneous distribution of entanglements, Mₑ can be calculated from G°_{N} via the formula G°_{N}=g_{N} ρ R T/Mₑ, where g_{N} is a numerical factor set at 1, rho (p) is the density in g/cm³, R is the gas constant and T is the absolute temperature in K. A low elastic modulus thus stands for long stretches of polymer between entanglements, and thus for a low degree of entanglement. The method is adopted from the investigation on changes in with the entanglements formation as described in: the publication of Rastogi, S., Lippits, D., Peters, G., Graf, R., Yefeng, Y. and Spiess, H., titled “Heterogeneity in Polymer Melts from Melting of Polymer Crystals”, Nature Materials, 4(8), 1 Aug. 2005, 635-641; and the PhD thesis of Lippits, D. R., titled “Controlling the melting kinetics of polymers; a route to a new melt state”, Eindhoven University of Technology, dated 6 Mar. 2007, ISBN 978-90-386-0895-2.

Such a disentangled polyethylene may be manufactured by a polymerisation process wherein ethylene is polymerised in the presence of a single-site polymerisation catalyst at a temperature below the crystallisation temperature of the polymer, so that the polymer crystallises immediately upon formation. Suitable methods for manufacturing polyethylene's used in the present invention are known in the art. Reference is made, for example, to WO 01/21668 and US 20060142521.

In one embodiment, the UHMWPE films used in the present invention have a high molecular orientation as is evidenced by their XRD diffraction pattern.

In a particular embodiment, the UHMWPE films have a 200/110 uniplanar orientation parameter Φ of at least 3. The 200/110 uniplanar orientation parameter Φ is defined as the ratio between the 200 and the 110 peak areas in the X-ray diffraction (XRD) pattern of the film sample as determined in reflection geometry. The 200/110 uniplanar orientation parameter gives information about the extent of orientation of the 200 and 110 crystal planes with respect to the film surface. For a film sample with a high 200/110 uniplanar orientation the 200 crystal planes are highly oriented parallel to the film surface. It has been found that a high uniplanar orientation is generally accompanied by a high modulus, high tensile strength and high tensile energy to break. The ratio between the 200 and 110 peak areas for a specimen with randomly oriented crystallites is around 0.4. However, in the films that are preferentially used in one embodiment of the present invention the crystallites with indices 200 are preferentially oriented parallel to the film surface, resulting in a higher value of the 200/110 peak area ratio and therefore in a higher value of the uniplanar orientation parameter. This parameter can be determined as described in WO 2009/109632.

UHMWPE films used in one embodiment of the ballistic material according to the invention have a 200/110 uniplanar orientation parameter of at least 3. It may be preferred for this value to be at least 4, more in particular at least 5, or at least 7. Higher values, such as values of at least 10 or even at least 15 may be particularly preferred. The theoretical maximum value for this parameter is infinite if the peak area 110 equals zero.

In a ballistic-resistant article described herein the UHMWPE films may have a thickness of 10-100 microns, in particular of 20-80 microns, more in particular 30-70 microns, and even more in particular 40-65 microns and may have a width of at least 2 mm, in particular at least 10 mm, more in particular at least 20 mm. The maximum width of the film is not critical and may generally be at most 500 mm.

UHMWPE films as used herein may generally have a high tensile strength, a high tensile modulus and a high energy absorption, reflected in a high energy-to-break.

In one embodiment, the tensile strength of the UHMWPE films is at least 1.2 GPa, more in particular at least 1.5 GPa, still more in particular at least 1.8 GPa, even more in particular at least 2.0 GPa. In one embodiment, the tensile strength of the UHMWPE films is at least 2.0 GPa, in particular at least 2.5 GPa, more in particular at least 3.0 GPa, still more in particular at least 4 GPa. Tensile strength is determined in accordance with ASTM D7744-11.

In one embodiment, the UHMWPE films have a tensile modulus of at least 50 GPa. More in particular, the films may have a tensile modulus of at least 80 GPa, more in particular at least 100 GPa, still more in particular at least 120 GPa, even more in particular at least 140 GPa, or at least 150 GPa. The modulus is determined in accordance with ASTM D7744-11.

In one embodiment, the UHMWPE films have a tensile energy to break of at least 20 J/g, in particular at least 25 J/g. In another embodiment, the tapes have a tensile energy to break of at least 30 J/g, in particular at least 35 J/g, more in particular at least 40 J/g, still more in particular at least 50 J/g. The tensile energy to break is determined in accordance with ASTM D7744-11. It is calculated by integrating the energy per unit mass under the stress-strain curve.

UHMWPE films used in the present invention may have a high strength in combination with a high linear density. The linear density expressed in dtex is the weight in grams of 10 000 metres of film. In one embodiment, the UHMWPE films have a denier of at least 3000 dtex, in particular at least 5000 dtex, more in particular at least 10 000 dtex, even more in particular at least 15 000 dtex, or even at least 20 000 dtex, optionally in combination with strengths of, as specified above, at least 2.0 GPa, in particular at least 2.5 GPa, more in particular at least 3.0 GPa, still more in particular at least 3.5 GPa, and even more in particular at least 4.

If so desired, UHMWPE films may have been subjected to a plasma or corona treatment, e.g., to improve their bonding properties.

Sheets of a ballistic-resistant article as described herein comprise at least a first layer of unidirectionally oriented UHMWPE films and a second layer of unidirectionally oriented UHMWPE films. If so desired an organic matrix material may be present at least between the first and the second layers of UHMWPE films.

In a ballistic-resistant article as described herein, sheets comprise at least two layers of ultra-high molecular weight polyethylene (UHMWPE) films. In particular, sheets may comprise at least 3, at least 4, or at least 6 layers of films and at most 20, at most 15 or at most 10 layers of films. Sheets comprising two layers of films may be preferred.

An organic matrix material may be present at least between the first and the second layers of UHMWPE films in a sheet. For instance, the organic matrix material may be present on the top and/or the bottom surfaces of the first and/or second layers of UHMWPE films provided that it is at least present between the first and second layers. In sheets having more than two layers of UHMWPE films, an organic matrix material is preferably present at least between all layers of films (i.e. between a layer of films and the adjacent layers of films). In several embodiments, the organic matrix material may additionally be present on the top surface of the top layer of sheet or on the bottom surface of the bottom layer of the sheet, i.e. on exposed surfaces having no adjacent layers of films. Having an organic matrix material on the top and bottom layers of the sheets may contribute to protecting the sheets against fibrillation, improving the wear resistance of the sheets and the ballistic-resistant article, e.g. during its preparation, handling and/or use.

The organic matrix material may be homogeneously or non-homogeneously distributed and may be continuously or discontinuously distributed between the first and second layers of UHMWPE films, and between any subsequent layers where it may be present. It is preferred for the organic material to be homogeneously and continuously distributed between the layers of UHMWPE films.

The organic matrix material is a polymer that bonds together the UHMWPE films.

The organic matrix material may preferably have a melting point below the melting point of the UHMWPE film.

The organic matrix material may have the same chemical make-up as the UHMWPE film. Alternatively, a polymer with a different chemical make-up may be used as organic matrix material. Examples of suitable organic matrix materials include polymers such as thermoplastic elastomers or polyolefin based polymers. Suitable thermoplastic elastomers include polyurethanes, polyvinyls, polyacrylates, block copolymers and mixtures thereof. In one embodiment, the thermoplastic elastomer is a block copolymer of styrene and an alpha-olefin comonomer. Suitable comonomers include C4-C12 alpha-olefins such as ethylene, propylene, and butadiene. Particular examples include polystyrene-polybutadiene-polystyrene polymer or polystyrene-isoprene-polystyrene. Such polymers are commercially available, e.g., under the trade name Kraton or Styroflex. Polyolefin based polymers may be preferred as organic matrix material. These polyolefins include polypropylene; polyethylene, such as high density polyethylene(HDPE), low density polyethylene (LDPE), medium density polyethylene (MDPE), linear low density polyethylene (LLDPE); ethylene α-olefin copolymers, such as ethylene-propylene copolymers and ethylene vinyl acetate copolymers; or combinations thereof.

It may be preferred for the organic matrix polymer material to be a polyethylene, preferably LDPE or HDPE. Such polymers have the same chemical make-up as the UHMWPE film, which advantageously allows for an easier recycling of the UHMWPE films provided with organic matrix material and ballistic-resistant articles manufactured therefrom. Further, polyethylene has good adhesive properties and is perfectly compatible with UHMWPE.

In an embodiment, the organic matrix material is present in an amount of 0.1 to 10 wt. %, or 0.2 to 6 wt. %, or 0.5 to 4 wt. %, or 0.75 to 3% based on the total weight of organic matrix material and UHMWPE films. It may be preferred for the amount of organic matrix material to be small, e.g. 0.1 to 4 wt. %. By having small amounts of organic matrix material (which generally is a material of low ballistic performance), the disruption of the performance of the UHMWPE film (which is a material with high ballistic performance) is minimal.

While the presence of a matrix material as described above is considered preferred, in some embodiments of the present invention a matrix material may be dispensed with. This is in particular the case where the UHMWPE film contains a fraction of PE of lower molecular weight which can serve as matrix to consolidate the films. The presence of such a fraction of lower molecular weight PE can be seen, e.g., from the melting profile of the UHMWPE film or from a determination of the molecular weight distribution by size exclusion chromatography or melt rheometry as described earlier.

The orientation of the UHMWPE films within the layer of films is unidirectional. Accordingly, UHMWPE films are aligned in parallel to form a layer.

UHMWPE films may partially overlap within a layer or may be aligned without an area of overlap between neighbouring films, e.g., films may be in abutting contact or there may be small gaps between neighbouring films. By small gaps it is understood that less than 5% of the areal surface of the layer corresponds to gaps. It may be preferred for the films within a layer not to overlap, in particular for the films to be aligned in abutting contact without significant gaps in between neighbouring films, e.g. less than 0.5% of the areal surface of the layer corresponds to gaps.

In a sheet of a ballistic-resistant article as described herein the direction of the UHMWPE films in the first layer is at an angle with respect to the direction of the films in the second layer. The angle between the orientation of the films in one layer and the orientation of the films in an adjacent layer may be from 45 to 135 degrees, or from 60 to 120 degrees, or from 85 to 95 degrees, or of about 90 degrees.

In a particular embodiment, the orientation of the films in one layer may be parallel with respect to the orientation of the films in alternate layers. In another embodiment the orientation of the films in one layer may be at an angle with respect to the orientation of the films in alternate layers. What is said above with respect to the angle between adjacent layers also applies to the angle between alternate layers.

In a ballistic-resistant article as described herein the sheets comprise discontinuous film splits through at least the first and the second layer of UHMWPE films. In sheets comprising more than two layers the discontinuous film splits are preferably present through all the layers constituting the sheets.

The term “discontinuous film splits” as used herein refers to localized areas of the films wherein the film partially splits along the direction of the UHMWPE polymer fibres constituting the film, also referred to as the length direction of the film. Thus, in each film layer film splits are present extending in the length direction of the UHMWPE film but said splits are discontinuous along the same length of the film.

The splits are generally induced in the UHMWPE film by application of a force onto a point in the film from which the split will spread (extending along the length direction of the film), such point may be referred to as the split centre. Methods for inducing discontinuous film splits are explained in more detail below.

Such discontinuous film splits allow the UHMWPE film to bend along the length of the polymer fibres constituting the UHMWPE film without deteriorating the integrity of the film, thereby increasing the flexibility of the sheets.

Since sheets as used herein have at least two layers with the direction of the films of one layer at an angle with respect to the direction of the films in the adjacent layer, the film splits in one layer of films are also at an angle with respect to the film splits in the adjacent layer of films, thereby the flexibility of the sheet is increased in at least two directions.

It has been surprisingly found that the presence of the discontinuous film splits contributes to the flexibility of the sheets, and of the ballistic-resistant article comprising the same, without detrimentally affecting the ballistic properties of the ballistic-resistant article. In particular, a ballistic-resistant article comprising sheets of UHMWPE films with discontinuous film splits have equivalent ballistic properties (e.g. v50, i.e. the velocity at which 50% of bullets are stopped, and v0, i.e. the zero penetration velocity) than a ballistic-resistant article with the same make up but without discontinuous film splits.

In the ballistic-resistant article according to the invention at least 50% of the split centres of a first layer are aligned along a line essentially perpendicular to the surface of the layer with the split centres of an adjacent second layer. In other words, in the ballistic-resistant article according to the invention of all splits in a first and second film layer, at least 50% is such that the centres of the splits are directly above each other. This can generally be achieved by providing the splits in a first layer and in a second layer in a single step, namely by providing the splits in the sheets, rather than in the films, e.g., using a needle. This is not only quite efficient from a process point of view, it is has also been found to be quite attractive from a product point of view as it makes for a homogeneous product. It is preferred for at least 70% of the split centres of a first layer to be aligned along a line essentially perpendicular to the surface of the layer with the split centres of an adjacent second layer, in particular at least 85%, more in particular at least 95%. In one embodiment of the present invention essentially all split centres of a first layer are aligned along a line essentially perpendicular to the surface of the layer with the split centres of an adjacent second layer. In this context essentially all means that all split centers of the splits in the first layer are aligned along a line essentially perpendicular to the surface of the layer with the split centres of an adjacent second layer except for inadvertent slips of the layers. In the context of the present specification the wording essentially perpendicular means that the direction is perpendicular to the surface of the sheet, taking the usually technical tolerances acceptable to the skilled person into account.

The density of the discontinuous film splits is from 1000 to 500 000 splits per m². In particular the density of the discontinuous film splits in the sheet may be from 5000 to 200 000 splits per m², even more in particular from 10 000 to 100 000 induced film splits per m². A lower density of film splits has been found to not contribute significantly to the flexibility of the sheets, on the other hand, a higher density of film splits may detrimentally affect the ballistic properties and/or integrity of the ballistic-resistant article.

The film splits may be separated by a radial distance of 0.5 to 100 mm, defined as the distance between a split centre and a neighbouring split centre in any direction of the film layer surface. In particular, the radial distance may be of 1 to 60 mm, or 2 to 40 mm, or 1.5 to 20 mm. It has been found that radial distances of split centres as specified may further contribute to the flexibility of the sheets and, ultimately, of the ballistic-resistant article.

The distance between film splits (split-to-split distance) in the length direction of the film, defined as the distance between a split centre and its nearest split centre in the direction of the film length, may preferably be from 2 to 100 mm, from 4 to 60 mm, or from 6 to 40 mm.

The split-to-split distance between a split centre and its nearest split centre in a direction other than the film length may preferably be from 0.5 to 20 mm, from 1 to 15 mm, or from 1.5 to 10 mm.

The distances between split centres can be easily determined by knowing the positions of the points where the splits are induced. For instance, when splits are induced by providing the sheets with stitches (e.g. using a needle provided with a thread), the distances between splits will be defined by the stitch length and the distance between stitching lines.

Discontinuous film splits may be preferably homogeneously distributed over the surface of the sheet, in order to provide a sheet and ballistic-resistant article with homogeneous properties throughout its surface.

In one embodiment the split centres of the film splits may be distributed forming straight lines. Such lines may be preferably at an angle with respect to the length direction of the UHMWPE films. The distance between split centres within a line may be smaller than between split centres of neighbouring lines. Such lines may additionally or alternatively be equally spaced throughout the surface of the sheet, resulting in an overall homogeneous distribution of the discontinuous film splits. In a particular embodiment said straight lines may be stitching lines.

The sheets in the stack of sheets of a ballistic-resistant article as described herein are consolidated. For instance, the sheets as such may be consolidated (individually) or the whole stack of sheets may be consolidated (together). If the sheets as such are individually consolidated, the whole stack does not need be consolidated but may also be consolidated.

The term consolidated as used herein means that the UHMWPE films in the sheet layers are firmly attached to one another by the organic matrix material.

In one embodiment the ballistic-resistant article comprises individually consolidated sheets wherein at least the first and second layers of UHMWPE films in the sheets are firmly attached to one another. In consolidated sheets comprising more than two layers of UHMWPE films, the films of all layers in the consolidated sheet are firmly attached to one another, i.e. the films in one layer are firmly attached to the films in adjacent layers.

In another embodiment, the stack of sheets of the ballistic-resistant article is consolidated as a whole, i.e. layers of UHMWPE films provided with an organic matrix material within a sheet and of adjacent sheets are firmly attached to one another.

A stack of individually consolidated sheets as described herein may be used in, e.g., a ballistic-resistant article for soft ballistic applications.

A consolidated stack of sheets as described herein may be used in, e.g., a ballistic-resistant article for hard ballistic applications.

Consolidation contributes to the integrity of the sheets and to the ballistic properties of the ballistic-resistant article.

Further, it has been surprisingly found that even after consolidation the sheets retain a significant part of the flexibility provided by virtue of the discontinuous film splits, in particular the flexibility is clearly enhanced compared to consolidated sheets without discontinuous film splits. Thus, by having individually consolidated sheets with discontinuous film splits, the stack of sheets may be advantageously used as a ballistic-resistant article in soft ballistic applications, e.g. a ballistic vest.

The sheets may be consolidated by the application of pressure and optionally heat, as it is known in the art and as it will be elucidated in more detail below.

In several embodiments, a ballistic-resistant article as described herein may comprise a thread stitched through at least part of the discontinuous film splits, whereby the sheet is provided with stitches. A thread may contribute to the integrity of the sheets. In particular, a thread may be useful for the preparation of a ballistic-resistant article by holding the first and second layers of UHMWPE films together prior to and optionally after consolidation, as explained in detail below. In addition, a thread may contribute to the integrity of the ballistic sheets within the ballistic article, e.g., upon a ballistic impact.

If present, the stitches may preferably be shorter than the width of the UHMWPE films in the film layer.

In several embodiments, the stitches may form straight lines. In a particular embodiment, the direction of lines of stitches may be at an angle with respect to the length direction of the UHMWPE films in the film layers. For instance, in a sheet with a 0-90 layer construction the lines of stitches may be at a 45° angle with respect to both the 0° and the 90° layers.

A stack of sheets as described herein may generally comprise at least 2 sheets, in particular at least 4, at least 6 or at least 8 sheets. Generally a stack of sheets may comprise at most 1000 sheets, and preferably at most 500 sheets or at most 250 sheets. The amount of sheets depends on the amount of film layers within one sheet and the threat level of ballistic resistance required. Suitable number of layers and sheets can be determined by a person skilled in the art.

A stack of sheets as described herein may as such conform a ballistic resistant article. Alternatively a stack of sheets as described herein may be further processed to form the ballistic resistant article.

For instance, the stack of sheets may be stitched together on the peripheral edges or placed in a holding bag to conform a ballistic-resistant article.

Alternatively or additionally, the stack of sheets may be combined with stacks or sheets of other ballistic-resistant materials, such as non-woven unidirectional layers (UDs) or woven fabrics of UHMWPE fibre, aramid fibre, or aramid copolymer fibre. For instance, in several embodiments the stack of sheets is combined with a stack of sheets of aramid fabric, in particular woven sheets of aramid or non-woven unidirectional layers of aramid (aramid UD). In a particular embodiment a ballistic-resistant article comprises from the impact side down, a stack of woven aramid sheets, a stack of UHMWPE sheets with discontinuous film splits as described herein and, optionally, a further stack of woven aramid sheets. It has been found that these constructions show improved ballistic performance as regards to reduced trauma, while maintaining good v50 (i.e. the velocity at which 50% of bullets are stopped) and v0 (i.e. the zero penetration velocity) as compared to standard aramid soft-ballistic articles constituted of sheets of woven aramid or aramid UD only.

Such ballistic resistant articles may be particularly suited for soft-ballistic applications, e.g. soft ballistic-resistant vests.

Alternatively or additionally, the stack of sheets may be shaped to provide a ballistic resistant article with a specific shape, e.g. a helmet, a single curved panel, a double curved panel, or a multi-curved panel.

Alternatively or additionally, the stack of sheets may be used in combination with other ballistic materials such as ceramic or steel strike faces. In a particular embodiment the stack of sheets may be shaped together with such ballistic materials, e.g. using vacuum consolidation as explained in detail below, so that the stack of sheets adapts to the shape of the additional ballistic material, e.g. a pre-shaped ceramic or steel strike face.

It has been found that the presence of the discontinuous film splits in the sheets of the stack facilitate the shaping of the ballistic resistant article, resulting in a ballistic-resistant article with improved shape, e.g. reduced wrinkles due to shaping, and improved thickness distribution, e.g. more homogeneous thickness throughout the shaped article.

Shaped articles may have the whole stack consolidated in the desired shape. Thus, as described in more detail below shaping may be performed at the same time as consolidation. Such articles may or may not additionally have the sheets in the stack individually consolidated. It may be preferred for shaped articles not to have the sheets in the stack individually consolidated, as non-individually-consolidated sheets have a greater flexibility, show good drapability and may be even more suited for shaping the ballistic resistant article than individually consolidated sheets. Such shaped ballistic resistant articles may be particularly suited for hard ballistic applications, e.g. hard ballistic-resistant vests, helmets and protective panels or shells.
1. The instant invention further relates to A process for the manufacture of a ballistic resistant article comprising a stack of sheets as defined in any one of claims 1-11, the process comprising the steps of:
   a. providing a first layer of unidirectionally oriented UHMWPE films;
   b. providing a second layer of unidirectionally oriented UHMWPE films on top of the first layer of UHMWPE films to form a sheet comprising at least the first and second layers of unidirectionally oriented UHMWPE films, with the direction of the films in the first layer at an angle with respect to the direction of the films in the second layer;
   c. optionally applying an organic matrix material to the UHMWPE films prior to, after and/or during step a) and/or step b), wherein, if used, the organic matrix material is present at least between the first and the second layers of films;
   d. inducing discontinuous film splits through at least the first and second layers of UHMWPE films to form a sheet comprising discontinuous film splits with a film split density of 1000 to 500000 film splits per m²;
   e. stacking a plurality of sheets comprising discontinuous film splits induced according to step d) to form a stack of sheets
   f. consolidating the sheets prior to and/or after stacking according to step e) by applying pressure and optionally heat.

The stack of sheets obtained according to a method described herein may conform a ballistic resistant article as such or may be further processed to obtain a ballistic resistant article.

A process as described herein comprises providing a first layer of unidirectionally oriented UHMWPE films (step a) and providing a second layer of unidirectionally oriented UHMWPE films on top of the first layer of UHMWPE films to form a sheet comprising at least the first and second layers of unidirectionally oriented UHMWPE films, with the direction of the films in the first layer at an angle with respect to the direction of the films in the second layer (step b).

To provide the first and second layers, the UHMWPE films are aligned in parallel, thereby forming a layer of unidirectionally oriented UHMWPE films or, in other words, whereby the orientation of the UHMWPE films within the layer of films is unidirectional.

The films may be aligned in parallel in an overlapping fashion. Alternatively and preferably, the films are aligned in parallel so that they do not overlap, e.g., films may be in abutting contact or there may be small gaps between neighbouring films, preferably in abutting contact without significant gaps in between neighbouring films, as described above for the ballistic-resistant article. Thereby, layers are obtained which have an homogeneous thickness, i.e. are free of areas of overlap.

Sheets may be formed by aligning a plurality of UHMWPE films to form a first layer of films and stacking a second layer of films on top of the first layer by aligning a plurality of UHMWPE films directly on top of said the first layer, thereby forming a sheet of at least two layers of films.

Additional layers of films may be stacked in a similar manner to form a sheet of, e.g., at least 3, 4, 6 or more layers as described above for the ballistic-resistant article.

The aligning and stacking of films is performed to provide a desired orientation of the films in the second layer with respect to the orientation of the films in the first layer, and optionally of subsequent layers, as described in detail above. In particular, UHMWPE films may be aligned on top of a first layer of UHMWPE films to form a second layer of UHMWPE films whereby the orientation of the films in the first layer is at an angle with respect to the orientation of the films in the second layer. With respect to preferred angles of orientation reference is made to what is described above for the ballistic-resistant article. For instance, a sheet may be provided with at least two layers in a 0-90 construction. Additional layers of UHMWPE films may be stacked to perpetuate such constructions until a sheet with a desired number of layers is obtained.

A process as described herein comprises applying an organic matrix material to the UHMWPE films prior to, after and/or during step a) and/or step b), whereby the organic matrix material is present at least between the first and the second layers of films (step c).

The organic matrix material is described above in the context of the ballistic-resistant article.

If used, the organic matrix material may be applied to the UHMWPE films in a manner known in the art. The method of application may depend on the type and form of the organic matrix material. For instance, it may be applied in solution or dispersion form, molten form or solid form.

Solutions and dispersions of organic matrix material are preferably applied by roll coating, but spraying may also be used. If a solution or a dispersion of the matrix material is used, the evaporation of the solvent or dispersant may occur prior, during or after the formation of the film layer. For instance, the matrix material may be applied in vacuo or under heat to facilitate the evaporation.

Molten organic matrix material may be applied for instance, using hot-melt application systems such as a so-called hot-melt pistol. If a molten matrix material is used, solidifying the molten matrix material may occur prior to, during or after the formation of the film layer.

Solid organic matrix material, such as monofilaments, strips, tapes, yarns, films or nets of a matrix material, may be positioned on the UHMWPE film and/or the film layer preferably also pressed against the film and/or film layer, e.g. by passing the solid organic matrix material together with the film and/or layer through a heated press. The film and the solid organic matrix material may optionally be co-stretched together.

The organic matrix material may be applied continuously or discontinuously. For instance, the organic matrix material may be applied defining one or more continuous or intermittent lines or stripes. The matrix material may also be applied as dots, distributed randomly or orderly (e.g. defining an intermittent line) on the UHMWPE films and/or film layers. The matrix material may also be applied defining a regular or irregular pattern.

The organic matrix material may be applied as a continuous layer covering part of or all the surface area of UHMWPE film or film layer by methods as described above. For instance, a solution of organic matrix material, a suspension of organic matrix material or an organic matrix material in solid or molten state may be laminated, rolled or sprayed onto the surface area of the UHMWPE film and/or film layer.

As described above the organic matrix material is present at least in between the first and second film layers. Thus, the organic matrix material may be applied on the top and/or the bottom surfaces of the first and/or second layers of UHMWPE films provided that it is at least present between the first and second layers. In sheets comprising more than two layers of films the organic matrix material is preferably applied at least between all the layers of films in the sheet, i.e. between a layer of films and the adjacent layers of films. In several embodiments, the organic matrix material may be additionally applied on the top surface of the top layer of sheet or the bottom surface of the bottom layer of the sheet, on a surface having no adjacent layers of films.

A process as described herein comprises inducing discontinuous film splits through at least the first and second layers of UHMWPE films to form a sheet comprising discontinuous film splits with a film split density of 1000 to 500000 film splits per m² (step d). In the process of this application the film splits are applied through at least the first and second layers of UHMWPE films simultaneously. In sheets having more than two layers of UHMWPE films, inducing discontinuous film splits is preferably performed through all the sheet layers.

Inducing discontinuous film splits may be performed by methods known in the art. For instance by using a needle or passing the sheet over a rotating drum provided with small pins. Inducing discontinuous film splits may be preferably performed by a needle. Optionally, inducing discontinuous film splits may be performed by a threaded needle whereby the sheet comprising discontinuous film splits is provided with a thread stitched through at least part of the discontinuous film splits. In a particular embodiment the sheet is provided with a thread stitched through at least 50%, 75% or 95% of the discontinuous film splits, in yet a particular embodiment through all of the discontinuous film splits in the sheet.

If present the thread is preferably thin, e.g. of a linear density of 10 to 500 dtex, in particular 20 to 200 dtex, more in particular 40 to 100 dtex, to prevent the addition of weight and of materials which do not contribute to the ballistic properties of the ballistic-resistant article.

The thread may be of any suitable material, e.g. a polyester (PES) thread, a polyolefin thread such as a polyethylene thread, a polyamide thread, a copolyamide thread, and an aramid thread. In one embodiment, the thread may be of the same material as the organic matrix material, e.g. a polyethylene thread.

In one embodiment, a thread may be used which has a lower melting point than the UHMWPE films. In particular, the use of a polyethylene (PE) thread having a melting point which is lower than the melting point of the UHMWPE films may be preferred.

Particularly preferred may be a thread which is of the same material of the organic matrix. Advantageously, such threads may contribute to the adhering of the layers of films in particular during a subsequent consolidating step. The use of such threads may be particularly advantageous for hard-ballistic applications, e.g. wherein the sheets are consolidated at least after stacking, in other words, wherein the stack of sheets is consolidated as a whole.

In another embodiment, a thread may be used which has a higher melting point than the UHMWPE films such as a polyester or aramid thread. The properties of these threads will be preserved after consolidation of the sheets. The use of such threads may be particularly advantageous for soft-ballistic applications, e.g. wherein the sheets are individually consolidated, in other words, wherein the sheets are consolidated prior to stacking.

What is said above with respect to film split density, distances and distribution for the ballistic-resistant article applies also to the method of preparation (with or without a thread).

A process as described herein comprises stacking a plurality of sheets comprising discontinuous film splits induced according step d) to form a stack of sheets (step e). Thereby the sheets are stacked on top of each other. The process comprises stacking at least two sheets, and optionally more sheets, to obtain a stack with a desired number of sheets as described above for the ballistic-resistant article.

Stacking of the sheets may be performed to achieve a desired film orientation within the stack. For instance two sheets of a 0-90 construction may be stacked to provide a 0-90-0-90 stack construction or to provide a 0-90-90-0 stack construction. Additional sheets may be stacked to perpetuate such constructions within the stack until a stack with a desired number of sheets is obtained. What is described above for the orientation and number of sheets in the ballistic-resistant article applies to its method of preparation.

A process as described herein comprises consolidating the sheets, prior to and/or after stacking according to step e) by applying pressure and optionally heat (step f).

Consolidation may be performed as it is known in the art. For instance, prior to stacking, an individual sheet with discontinuous film splits or, after stacking, a whole stack of sheets may be placed in a press and subjected to compression. The required compression time and compression temperature depend on the nature of the UHMWPE films and organic matrix material, on the presence and nature of a thread stitched through the discontinuous film splits, and on the thickness of the sheet to be consolidated, and can be readily determined by a person skilled in the art. A pressure of, for instance, at least 0.1 MPa and at most 50 MPa may be applied. The use of pressure may suffice to cause the UHMWPE films in the sheet to adhere to each other through the organic matrix material. However, where necessary, the temperature during compression may be selected such that the organic matrix material and/or the stitching thread (if any) is brought above its softening or melting point, if this is necessary to cause the matrix to help adhere the UHMWPE films to each other.

Consolidation may be performed at a compression temperature above the softening or melting point of the organic matrix material and below the melting point of the UHMWPE films. Where the compression is carried out at such temperature, it may be preferred for the cooling of the compressed material (i.e. the sheet with discontinuous film splits) to also take place under pressure, whereby a given minimum pressure is maintained during cooling at least until a temperature is reached at which the structure of the sheet can no longer relax under atmospheric pressure. It is within the scope of the skilled person to determine this temperature on a case by case basis. Where applicable it is preferred for cooling to be performed at the given minimum pressure to reach a temperature at which the organic matrix material has largely or completely hardened or crystallized and below the relaxation temperature of the UHMWPE film. The pressure during the cooling does not need to be equal to the pressure used for consolidation. During cooling, the pressure may be monitored so that appropriate pressure values are maintained, to compensate for decrease in pressure caused by shrinking of the sheet or the stack of sheets in the press.

The consolidation as described above may be performed in a static press or in a continuous process. Suitable continuous processes comprise, but are not limited to, lamination, calandering and double-belt pressing.

A method as described herein provides a stack of sheets which as such may conform a ballistic resistant article or may be further processed to obtain a ballistic resistant article.

For instance, further steps in a process described herein may include stitching together the peripheral edges of the stack of sheets or placing the stack of sheets in a holding bag.

The process may further comprise combining the stack of sheets of UHMWPE film layers with discontinuous film splits with stacks or sheets of other ballistic-resistant materials. In particular a plurality of sheets of other ballistic-resistant materials (e.g. an aramid fabric such as a woven or UD aramid sheet) may be stacked on top, and optionally also at the bottom, of the shack of sheets of UHMWPE film layers with discontinuous film splits to form a ballistic-resistant article comprising from the impact side down, a stack of woven or UD aramid sheets, a stack of UHMWPE sheets with discontinuous film splits as described herein and, optionally, a further stack of woven or UD aramid sheets as described above for the ballistic-resistant article.

The process may further comprise shaping the stack of sheets of UHMWPE film layers with discontinuous film splits to provide a ballistic resistant article with a specific shape, e.g. a helmet, a curved panel, a multi-curved panel, as described above.

A stack of sheets as described herein may also be combined with a ceramic or steel strike face, in particular the stack may be shaped against a pre-formed ceramic or steel strike face. This may be performed, e.g., by vacuum forming a panel: placing a ceramic or steel strike face and a stack of sheets comprising discontinuous film splits as described herein into a vacuum chamber and compressing by applying vacuum, i.e. vacuum consolidation.

It has been found that the presence of the discontinuous film splits in the sheets of the stack facilitates the shaping of the ballistic resistant article. In particular, stacks of sheets comprising discontinuous film splits as described herein have good draping properties which are advantageous for shaping. Shaping may comprise moulding the whole stack of sheets under, e.g. pressure and optionally heat. In this particular embodiment, the whole stack may be consolidated in the desired shape by the moulding process. Thus, shaping the stack of sheets by moulding may be performed simultaneously to consolidating the sheets after stacking.

For the formation of a helmet from a stack of sheets reference is made to WO 2013/124233, which describes a ballistic-resistant article comprising a double curved shell comprising a stack of plies with a plurality of cuts which is consolidated in a concave mould by applying elevated temperature and pressure.

The instant invention also relates to ballistic resistant articles obtainable by a process as described herein.

The instant invention is further illustrated by the following examples without being limited thereto or thereby.

### EXAMPLES

### Example 1—Preparation of Sheets with Film Splits

### Example 1A—Sheet Assembly of Two UHMPE Layers with HDPE Matrix and PES Thread Through the Splits

An UHMWPE film with a co-stretched HDPE matrix content of 1·5 wt % with a thickness of 47 μm, a width of 132.8 mm and a modulus of 186.4 N/tex was used as a starting material.

A first layer of films was positioned on a moving belt under an angle of 45 degree with the running direction of the belt. A second layer of films was positioned on top of the first layer under an angle of 90 degrees with respect to the first layer.

The assembly of two film layers was transported to a sewing station. The layers were stitched together with a 48 dtex polyester (PES) sewing thread. Stitching lines ran parallel to direction of the moving belt. The stitching lines were separated by 0.2 inch (0.51 cm). The stitch length distance was 2.6 mm. The stitching resulted in the formation of film splits centred around the point where the needle impacted the film layers. After the stitching station, the sheet was wound on a core.

### Example 1B—Sheet Assembly of Two UHMWPE Layers with HDPE Matrix and PES Thread Through Part of the Splits

A similar sheet was prepared as in Example 1A, with the difference that in the sewing station only 1 out of 5 equally spaced needles was equipped with PES sewing thread. This resulted in split lines separated by 0.2 inch (0.51 cm), i.e. having a film split distance perpendicular to the production direction of 0.2 inch (0.51 cm), but where only 1 out of 5 split lines had a thread defining a sewing line, i.e. defining a sewing thread-to-sewing thread distance of 1 inch (2.54 cm).

### Example 1C—Sheet Assembly of Two UHMWPE Layers with HDPE Matrix and Copolyamide Fusible Thread Through the Splits

A similar sheet was prepared as in Example 1A, but where the sewing thread was replaced by a copolyamide fusible thread commercially available as Grilon K-85 75 dtex.

### Example 1D—Sheet Assembly of Two UHMWPE Layers with LDPE Matrix and PES Thread Through the Splits

A similar sheet was prepared as in Example 1A, but where the matrix was changed from HDPE to LDPE and the matrix content was 2 wt %.

### Example 2—Helmet from Sheets of UHMWPE Films with Discontinuous Film Splits

Sheets were prepared according to Example 1A, but with the difference that the stitch line distance was 0.4 inch (1.02 cm).

Each sheet was consolidated on a Schott and Meisner laminator at a temperature of 135° C. Two consolidated sheets were laminated together to form a 4-ply consolidated sheet. These 4-ply consolidated sheets were cut into a pattern consisting of a central circle and four lobes.

A total of 52 4-ply sheets cut as described above were stacked together, wherein each sheet was rotated over an angle of 3.9° compared to the previous sheet. In the middle the stack was fixed by hot welding at 90° C. The stack was put into a helmet shaped preform which was kept at a temperature of 60° C. and under a pressure of 4 bars for 4 minutes. Subsequently, the preform was put into a 60° C. preheated helmet mold and pressed at 55 bars. The mold was heated, keeping the pressure at 55 bars and after 30 minutes a temperature of 136° C. was reached. The temperature was held for further 30 minutes, and subsequently the mold was cooled down under a pressure of 55 bars to 60° C. within 30 minutes. Then the consolidated shape was removed from the mold. With a belt-saw the consolidated shape was cut into the final helmet shape.

The helmet was evaluated using 1.1 g fragment simulating projectiles (FSP). Results are shown in Table 1.

### Comparative Example 1—Helmet from Sheets of UHMWPE Films without Discontinuous Film Splits

Using the same process of Example 2 a helmet was prepared based on commercially available Endumax XF33. Endumax XF33 is built-up of 4 UHMWPE film layers in a 0-0-90-90 configuration, where the two first layers are positioned in a brick construction (i.e. in the same direction but offset with respect to each other) and where the third and fourth layer are rotated 90° with respect to the first and second layer, said third and fourth layers being also positioned in a brick construction with respect to each other. All film layers are adhered to one another using a Kraton based glue.

A total of 52 sheets of Endumax XF33 were used to achieve a helmet of equal weight to that of Example 2.

The helmet was evaluated using 1.1 g fragment simulating projectiles (FSP). Results are shown in Table 1.

TABLE 1

| | Weight | Trauma first shot | v50 |
|---|---|---|---|
| Sample | (g) | (mm) | (m/s) |
| Example 2 | 756 | 18 | 842 |
| Comparative | 755 | 21 | 750 |
| Example 1 | | | |

The results of Table 1 clearly show that the helmet shell prepared according to the invention (Example 2) has far better performance than helmets obtained with commercially available materials (Comparative Example 1). Furthermore, both in the preform step as in the final consolidation step, the material according to the invention (Example 2) was more easily drapable and formed more easily into the required shape resulting in a helmet shape with a more even thickness distribution.

### Example 3—Hard Ballistic Ceramic Insert with Backing of UHMWPE Films with Discontinuous Film Splits

The UHMWPE sheet material obtained according to Example 1A was cut in sheets with dimensions 280×320 mm. 68 of these 280×320 mm sheets were stacked on top of a 8.5 mm Alotec-Ceramic insert. The total areal weight of the stack of 68 sheets (excluding the ceramic insert) was 5.1 kg/m². One layer of commercially available Nolax foil F222031 of 250 g/m², which serves as an adhesive, was placed in between the Alotec-Ceramic insert and the stack of sheets

The complete assembly was placed in a vacuum-bag and processed in a vacuum oven at 135° C. for 50 minutes. After the core temperature reached 135° C. the temperature was maintained for 10 minutes after which cooling was started until the core reached 60° C. Vacuum was maintained during the whole cycle.

During consolidation of the assembly the core temperature was measured with a thermocouple inserted in the middle of the stack.

It was found that the material according to the invention had good drapability enabling the production of high quality ceramic inserts with UMHPWE film based backing.

### Comparative Example 2—Hard Ballistic Ceramic Insert with Backing of UHMWPE Films without Discontinuous Film Splits

The same procedure as in Example 3 was used to prepare an ceramic insert with a UHMWPE backing wherein instead of UHMPE sheets with film splits of Example 1A, sheets of commercially available Endumax XF33 (with the same configuration as described in comparative example 1) were used. 35 Endumax XF33 sheets were stacked on top of a 8.5 mm Alotec-Ceramic insert to form a UHMWPE backing having a total areal weight of 5.1 kg/m² (excluding the ceramic insert). The complete assembly was placed in a vacuum-bag and processed in a vacuum oven at 140° C. After 46 minutes the core temperature reached 129° C. The temperature was maintained for 10 minutes after which cooling was started until the core reached 60° C. Vacuum was maintained during the whole cycle

The drapability of the UHMWPE backing was not as good as the drapability of the backing of Example 3 according to the invention. After consolidation the backing of Comparative Example 2 showed large wrinkles, which are undesired from a performance point of view and make it unsuitable for production of high quality ceramic inserts with UMHPWE film based backing.

### Comparative Example 3—Soft Ballistic Panel with Aramid Strike Face and Backing of UHMWPE Films without Discontinuous Film Splits

An UHMWPE film with a co-stretched HDPE matrix content of 1.5 wt % with a thickness of 47 μm, a width of 132.8 mm and a modulus of 186.4 N/tex was used as a starting material.

A first 0-90 crossply of this material (sheet A) was produced on a Meyer lab laminator in the following manner:

Three rolls of said UHMWPE 133 mm wide film were positioned in an unwinding station. These films were led into the laminator with a minimal gap in between the films, so that the three films were aligned in parallel in abutting contact but without overlap, to form a bottom 0 degree film layer. On top of this 0 degree layer, three films of the same width and of 40 cm in length were positioned perpendicular to the 0 degree layer just before the entrance of the laminator forming a 90 degree film layer. The films in the 90 degree layer were manually positioned to achieve minimal overlap. After lamination a consolidated 0-90 cross-ply was obtained which was wound on a winding station.

In a second step, a second 0-90 cross-ply (sheet B) was produced on the same laminator as described above for sheet A except that, instead of three 133 mm wide films, four films were fed into the laminator, of which two had a width of 66.5 mm and two had a width of 133 mm.

In a third step, the cross-ply sheet A and the cross-ply sheet B were unwound and led into a laminator simultaneously to form and consolidate a 0-90-0-90 stack of cross-ply sheets. The consolidated stack of sheets was wound on a winding station.

The 0-90-0-90 consolidated cross-ply sheets were cut to dimensions of 30×30 cm and 24 of these 30×30 cm cuts were stacked on top of each other. This stack was combined with 6 layers of a Twaron CT619 fabric (a high tenacity aramid woven fabric) on the strike face and stitched completely around the edges to obtain a soft ballistic panel with an areal weight of 4.7 kg/m².

In total two panels were prepared which were shot 4 times each with 0.44 Magnum. The back-face deformation was averaged over all 8 shots and found to be 45 mm.

### Example 4—Soft Ballistic Panel with Aramid Strike Face and Backing of UHMWPE Films with Discontinuous Film Splits

Two sheet assemblies of two UHMPE layers with HDPE matrix and PES thread through the splits as described in Example 1A were fed into a laminator to obtain a consolidated material consisting of 4 film layers in a 0-90-0-90 configuration. 24 sheets of such 4-film layered material were cut with dimensions of 30×30 cm and stacked on top of each other. This stack was combined with 6 layers of a Twaron CT619 fabric on the strike face and stitched around completely to obtain a soft ballistic panel with an areal weight of 4.7 kg/m².

In total two panels were prepared which were shot each 4 times with 0.44 Magnum. Average back-face deformation was 42 mm, clearly showing improved ballistic performance over a material without film splits as described in comparative example 3.

### Evaluation of Stiffness

Stiffness of the different sheet material constructions was measured with a method derived from ASTM 4032.

Each sheet assembly of Examples 1A, 1B, and 1C was consolidated on a Schott and Meisner laminator at a temperature of 135° C. The sheet assembly of Example 1D was consolidated in a static press at 25 bar and 130° C.

As comparison, the stiffness was also evaluated for an Endumax XF33 sheet assembly (built-up of 4 UHMWPE film layers in a 0-0-90-90 configuration used in Comparative Examples 1 and 2) and for a sheet A assembly (built up of 2 UHMWPE film layers in a 0-90 configuration as described for sheet A in Comparative Example 3).

Samples of 10.2×20.4 cm were cut from each sheet material, with the 10.2 cm length in the direction of the stitch-lines (if present). Two samples were folded to obtain a four-sheet-layer sample of 10.2×10.2 cm. Several samples were placed on top of each other in the same way to form a stack. The stack was placed on a flat smooth polished metal plate with a circular hole of 1 inch diameter in the centre. The metal plate was positioned in a holder in a tensile tester, equipped with a rod positioned above the centre of the hole. In the stiffness measurement the rod pushed the stack through the hole with a speed of 5 mm/s. The stiffness was calculated as the initial slope in the 0 to 5 mm displacement region from the force-displacement curve. For comparison between samples the stiffness is divided by the areal weight resulting in a specific modulus (N/g).

The specific modulus of several materials is shown in Table 2. A lower specific modulus indicates an increased flexibility.

As can be seen from table 2 the stiffness is clearly diminished with materials comprising film splits according to the invention (Examples 1A-1D) when compared to materials not comprising film splits (Endumax XF33 and Sheet A).

TABLE 2

| | Sheet | | Specific modulus |
|---|---|---|---|
| Sample | Construction | Film splits | (N/g) |
| Endumax XF33 | 0-0-90-90 | no | 157.5 |
| Sheet A | 0-90 | no | 88.7 |
| Example 1A | 0-90 | yes | 52.9 |
| Example 1B | 0-90 | yes | 54.4 |
| Example 1C | 0-90 | yes | 45.0 |
| Example 1D | 0-90 | yes | 70.0 |

1. A ballistic-resistant article comprising a stack of sheets, the sheets comprising at least a first layer of unidirectionally oriented UHMWPE films and a second layer of unidirectionally oriented UHMWPE films, the direction of the films in the first layer being at an angle with respect to the direction of the films in the second layer, wherein the sheets comprise discontinuous film splits through at least the first and the second layers of films, the density of the film splits being from 1000 to 500000 film splits per m² and wherein the sheets in the stack are consolidated, wherein at least 50% of the split centres of a first layer are aligned along a line essentially perpendicular to the surface of the layer with the split centres of an adjacent second layer.

2. The ballistic-resistant article of claim 1, wherein the film splits are separated by a radial distance, defined as the distance between a split centre and a neighbouring split centre in any direction of the film layer surface, from 0.5 to 100 mm.

3. The ballistic-resistant article of claim 2, wherein the density of the discontinuous film splits is from 5000 to 200000 film splits per m².

4. The ballistic-resistant article of claim 1, wherein the split centres of the film splits are distributed forming straight lines the straight lines optionally being at an angle with respect to the length direction of the UHMWPE films.

5. The ballistic-resistant article of claim 1, comprising a thread stitched through at least part of the discontinuous film splits.

6. The ballistic-resistant article of claim 5 wherein the thread has a linear density of 10 to 500 dtex.

7. The ballistic-resistant article of claim 1, wherein the angle of the direction of the UHMWPE films in the first layer with respect to the direction of the films in the second layer is from 45 to 135 degrees.

8. The ballistic-resistant article of claim 1, wherein the sheets comprise 2 layers of UHMWPE films.

9. The ballistic-resistant article of claim 2, wherein an organic matrix material is present at least between the first and the second layers of UHMWPE films, wherein the organic matrix material is present in an amount of 0.1 to 10 wt. % based on the total weight of organic matrix material and UHMWPE films.

10. The ballistic-resistant article of claim 9, wherein the organic matrix material is a high density polyethylene (HDPE) or a low density polyethylene (LDPE).

11. The ballistic-resistant article of claim 1, wherein the stack of sheets has the sheets stitched together on their peripheral edges and/or the stack of sheets is placed inside a holding bag and/or the stack of sheets is shaped.

12. A process for the manufacture of a ballistic resistant article comprising a stack of sheets as defined in claim 1, the process comprising the steps of:
a. providing a first layer of unidirectionally oriented UHMWPE films;
b. providing a second layer of unidirectionally oriented UHMWPE films on top of the first layer of UHMWPE films to form a sheet comprising at least the first and second layers of unidirectionally oriented UHMWPE films, with the direction of the films in the first layer at an angle with respect to the direction of the films in the second layer;
c. optionally applying an organic matrix material to the UHMWPE films prior to, after and/or during step a) and/or step b), wherein, if used, the organic matrix material is present at least between the first and the second layers of films;
d. inducing discontinuous film splits through at least the first and second layers of UHMWPE films to form a sheet comprising discontinuous film splits with a film split density of 1000 to 500000 film splits per m²;
e. stacking a plurality of sheets comprising discontinuous film splits induced according to step d) to form a stack of sheets
f. consolidating the sheets prior to and/or after stacking according to step e) by applying pressure and optionally heat.

13. The process of claim 12 wherein inducing discontinuous film splits of step d) is performed by a needle to form the sheet with discontinuous film splits, optionally by a threaded needle whereby the sheet is provided with a thread stitched through at least part of discontinuous film splits.

14. The process of claim 12 further comprising stitching the stack of sheets together on the peripheral edges and/or placing the stack of sheets in a holding bag and/or shaping the stack of sheets by moulding, wherein shaping the stack of sheets by moulding is performed simultaneously to consolidating the sheets.

15. A ballistic resistant article obtainable by the process of claim 12.
